(19) United States
(12) Patent Application Publication
(10) Pub. No.: US 2002/0084621 A1
(43) Pub. Date: Jul. 4, 2002

(54) Support leg of scooter

(76) Inventor: Shui-Te Tsai, Chang Hua (TW)

Correspondence Address: BROWDY AND NEIMARK, P.L.L.C., 624 NINTH STREET, NW, SUITE 300, WASHINGTON, DC, 20001-5303, US

(21) Appl. No.: 09/752,454

(22) Filed: Jan. 3, 2001

(51) Int. Cl. B62B 13/00; B62B 17/00

(52) U.S. Cl. 280/293; 280/14.21

(57) ABSTRACT

A scooter supporting leg is formed of a fastening mount, a leg, an elastic member, a collar, and a stop pillar. The fastening mount is fastened with the scooter footboard and is provided with a pivoting portion to which the leg is pivoted. The leg is provided with a stop ring. The elastic member is disposed between the fastening mount and the stop ring of the leg for locating the leg at the support side or the folding side of the fastening mount. The collar serves to facilitate the turning of the leg smoothly. The stop pillar is intended to locate the leg.

### FIELD OF THE INVENTION

The present invention relates generally to a scooter, and more particularly to a support leg of the scooter.

### BACKGROUND OF THE INVENTION

The conventional scooters are devoid of a support leg by means of which the scooter can be parked uprightly. In light of the lack of the support leg, the conventional scooters are generally parked in such a fashion that the scooters are leaned against a stationary object or wall. Unlike a bicycle or motorcycle, the scooter is relatively small in volume.

### SUMMARY OF THE INVENTION

The primary objective of the present invention is to provide a scooter with a support leg enabling the scooter to be rested uprightly.

The support leg of the present invention comprises a fastening mount, a leg, an elastic member, a collar, and an arresting pillar. The fastening mount is fixedly attached to the scooter footboard and is provided with a pivoting portion to which the leg is pivoted. The leg is provided with a stop ring. The elastic member is disposed between the fastening mount and the stop ring of the leg, thereby enabling the leg to be located at the support side and the folding side of the fastening mount.

### BRIEF DESCRIPTION OF THE DRAWINGS

FIG. 1 shows a schematic view of the present invention.

FIG. 2 shows a sectional view taken along the direction indicated by a line 2-2 as shown in FIG. 1.

FIG. 3 shows a schematic view taken along the direction “A” as shown in FIG. 2.

FIG. 4 shows an exploded view of a preferred embodiment of the present invention.

FIG. 5 shows a schematic view of the present invention in the folding state.

FIG. 6 shows a schematic view of another preferred embodiment of the present invention.

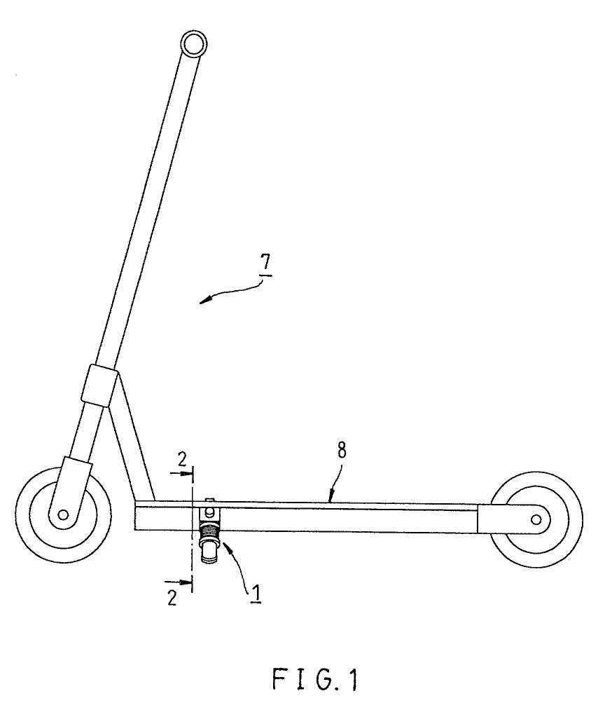

### DETAILED DESCRIPTION OF THE INVENTION

As shown in all drawings provided herein, a support leg 1 of the present invention is pivoted to a footboard 8 of a scooter 7. The footboard 8 comprises an upper piece 81, two side pieces 83 fastened at an interval to the underside of the upper piece 81 such that the side pieces 83 are perpendicular to the upper piece 81, and a lower piece 85 fastened with the two side pieces 83, a receiving space 87 located respectively at the outer sides of the upper piece 81 and the side pieces 83, and two fastening holes 89.

The support leg 1 comprises a fastening mount 10, a leg 30, a compression spring 50, a collar 60, and a stop pillar 70.

The fastening mount 10 has a seat 11 which is disposed in the receiving space 87 of the footboard 8, two threaded holes 111, and two pivoting lugs 13. The fastening mount 10 is fixed with the footboard 8 by two bolts 20 which are engaged with the threaded holes 111 and the fastening holes 89. The pivoting lugs 13 are perpendicular to the seat 11 to form a slot 14 and are provided with a pivoting hole 131, a threaded hole 133, a support side 15, a folding side 19 perpendicular to the support side 15, and a round corner 17.

The leg 30 has a pivoting seat 31 which is provided with a pivoting hole 311 for receiving a bolt 40 engaging the pivoting hole 131 of the fastening mount 10, a support rod 33 connected with the pivoting seat 31 for making contact with the ground surface, and a stop ring 35 disposed on the support rod 33.

The compression spring 50 is fitted to the support rod 33 of the leg 30 such that one end 51 of the spring 50 urges the stop ring 35.

The collar 60 has a fitting hole 61 which is fitted over the support rod 33 of the leg 30 such that one end of the collar 60 is rested against other end 53 of the spring 50, and that other end of the collar 60 is rested against the pivoting lug 13 of the fastening mount 10.

The stop pillar 70 is disposed at the pivoting lug 13 of the fastening mount 10 for stopping the rod body 33 of the leg 30, so as to prevent deflection of the leg 30.

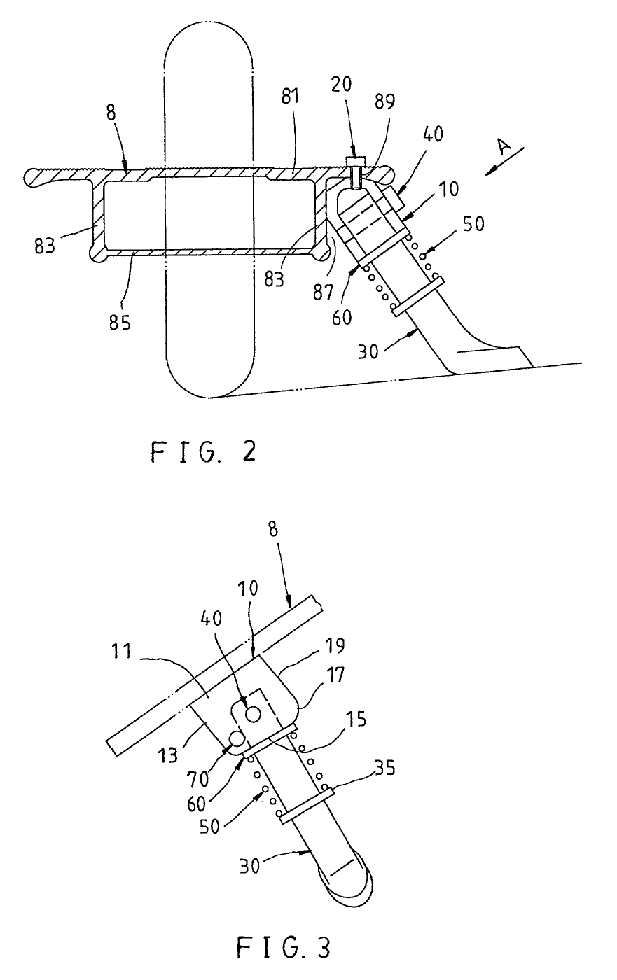

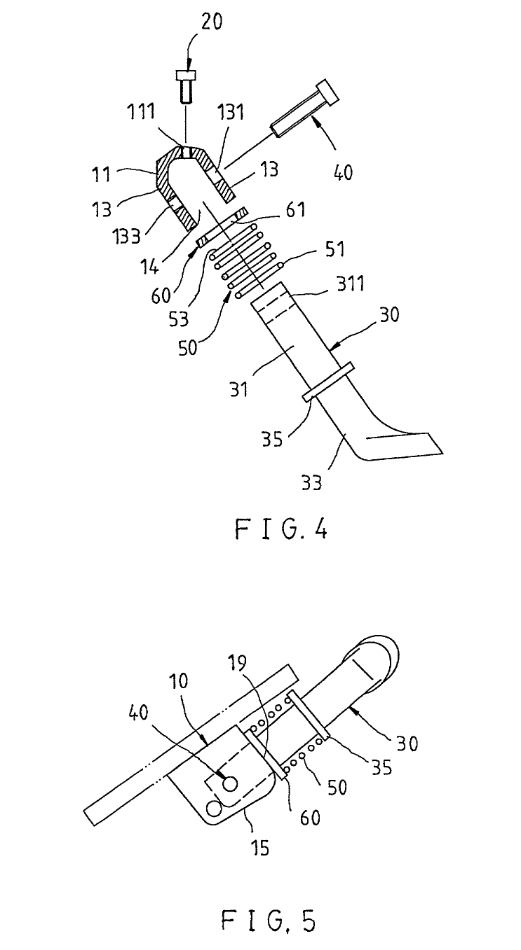

As shown in FIGS. 2-4, as the support rod 33 of the support leg 30 is turned toward the ground surface, the collar 60 is forced by the spring 50 to locate at the support side 15. In the meantime, the leg 30 is stopped by the stop pillar 70. The scooter is thus rested uprightly on the ground surface. On the contrary, if the support rod 33 of the leg 30 is turned to compress the spring 50, which is turned to the round corner 17, and then to the folding side 19 to enable the spring 50 to urge the collar 60, as shown in FIG. 5. The leg 30 of the support leg 1 is thus folded.

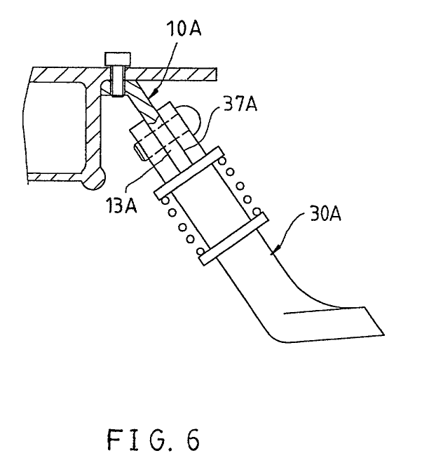

The two pieces of the fastening mount of the support leg of the present invention are not confined to be in the inverted U-shaped construction and may be separately fastened with the scooter footboard. As shown in FIG. 6, the fastening mount 10A of another preferred embodiment of the present invention has a single pivoting lug 13A. The leg 30A is provided with a slot 37A fitted pivotally with the pivoting lug 13A.

The elastic member of the present invention may be a plate spring or rubber block in place of the compression spring.

What is claimed is:

1. A support leg of a scooter, said support leg comprising:
a fastening mount having a seat which is fastened to the footboard of the scooter, a pivoting portion, a support side, and a folding side contiguous to said support side;
a leg pivoted to said pivoting portion of said fastening mount and provided with a stop ring; and
an elastic member disposed between said fastening mount and said stop ring of said leg for locating said leg at said support side or said folding side of said fastening mount whereby said elastic member forces said leg to locate at said support side of said fastening mount, thereby enabling said leg to support the scooter uprightly on the ground surface, said leg being capable of turning to locate at said folding side of said fastening mount.

2. The support leg as defined in claim 1, wherein said elastic member is a compression spring.

3. The support leg as defined in claim 2, wherein said compression spring is fitted over said leg.

4. The support leg as defined in claim 1, wherein said fastening mount is provided with a stop pillar for stopping and locating said leg.

5. The support leg as defined in claim 4, wherein said stop pillar is a rod which is inserted into said seat.

6. The support leg as defined in claim 1, wherein said elastic member and said fastening mount are provided with a collar disposed therebetween.

7. The support leg as defined in claim 1, wherein said support side and said folding side of said fastening mount are substantially perpendicular to each other.

8. The support leg as defined in claim 1, wherein said support side and said folding side of said fastening mount form an arcuate corner.

9. The support leg as defined in claim 1, wherein said fastening mount is of a single-piece construction.

10. The support leg as defined in claim 1, wherein said fastening mount is of a two-piece construction.

11. The support leg as defined in claim 1, wherein said fastening mount is of an inverted U-shaped construction.
